(19) United States
(12) Patent Application Publication
(10) Pub. No.: US 2009/0147001 A1
(43) Pub. Date: Jun. 11, 2009

(54) COMPUTER PROGRAM TO OUTPUT CONTRAST ENHANCED MEDICAL IMAGE DATA

(75) Inventors: Thomas Buelow, Grosshansdorf (DE); Rafael Wiemker, Kisdorf (DE); Lina Arbash Meinel, Homewood, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/300,536

(22) PCT Filed: May 14, 2007
(86) PCT No.: PCT/IB2007/051819

§ 371 Date: Nov. 12, 2008

(30) Foreign Application Priority Data
May 17, 2006 (EP) 06114095.0

(51) Int. Cl. G06T 17/00; G06K 9/00

(52) U.S. Cl. 345/424; 382/128

(57) ABSTRACT

A string of computer instructions is presented to output medical image data containing voxels representative of contrast enhanced material, and arranged to operate on a first object data set comprising voxels depicting contrast enhancement, whereby it segments a sub-set of voxels in the first object data set which voxels describe contrast enhanced vessels, and uses the results of the segmentation to partition the voxels depicting contrast enhancement into a first group of voxels describing the segmented vessels and a second group of voxels describing the remaining contrast enhanced voxels, and uses the partition to output a second object data set comprising voxels depicting contrast enhancement in which the difference between the voxels of the first group and the voxels of the second group is identifiable. It is particularly advantageously applied to dynamic contrast enhanced breast imaging.

The invention relates to a string of computer instructions to output contrast enhanced medical image data, the string arranged to operate on a first object data set comprising voxels depicting contrast enhancement and arranged to identify the voxels depicting contrast enhancement.

Contrast enhanced imaging uses contrast agents, or otherwise methods of enhancing contrast, to increase relative contrast within portions of an image to provide for improved diagnosis. In ‘Comparison of Automatic Time Curve Selection Methods for Breast MR CAD’, Tanya Niemeyer et al, Medical Imaging 2004: Image Processing, edited by J. Michael Fitzpatrick, Milan Sonka; Proceedings of SPIE, vol. 5370, describes the use of dynamic contrast enhanced breast magnetic resonance to identify suspicious breast lesions by identifying those voxels which show a sufficiently high percentage enhancement. The washout curve of the contrast agent can be used to differentiate between malignant lesions and benign lesions since it is known that malignant lesions tend to show increased washout of the contrast agent due to the increased permeability of the tumor vascular bed, whilst benign lesions tend to show persistent uptake. The washout profile can be calculated for regions of interest defined over any areas of increased contrast in the resulting images. The result of the method is a group of washout profiles for the regions of interest which can be used to diagnose malignancy. Unfortunately, the areas of increased interest include non lesion material.

It is an object of the invention to produce contrast enhanced medical image data which allows the more accurate detection of contrast enhanced lesions.

This is achieved according to the invention whereby the string is arranged to segment a sub-set of voxels in the first object data set which voxels describe contrast enhanced vessels,

and further arranged to use the results of the segmentation to partition the voxels depicting contrast enhancement into a first group of voxels describing the segmented vessels and a second group of voxels describing the remaining contrast enhanced voxels,

and further arranged to use the partition to output a second object data set comprising voxels depicting contrast enhancement in which any voxels in the first group are visually marked as being of the first group and in which any voxels in the second group are visually marked as being in the second group.

The features of allowing segmentation of the contrast enhanced vessels in an object data set which contains contrast enhanced voxels, and use of that segmentation to generate a partition of the contrast enhanced voxels into vessel voxels and non-vessel voxels and thereby allow production of an object data set in which the visual difference between the contrast enhanced vessel voxels and contrast enhanced non-vessel voxels is easily identified allows identification of any contrast enhanced blood and lymph supply in the tissue and therefore identification of the anatomical channels through which the contrast agent flows. It is found that this allows differentiation between voxels describing lesions and other contrast enhanced voxels which do not describe lesions. It has the specific advantage that contrast enhanced vessel material can be identified, even when the object data set is displayed as an image in which vessel material, due to its orientation, is shown in a transverse alignment with the plane of the image. Such vessels frequently appear in a plane image as a small rounded area of contrast enhanced material and are easily confused with lesion material.

The invention therefore this solves the problem of how to more accurately detect contrast enhanced lesions and in particular solves the problem of how to differentiate on a contrast enhanced image between genuine isolated lesions and small cross sections of contrast enhanced vessel.

Visual marking can be usefully achieved through the use of color in the displayed resultant image. Separate colors, or ranges of colors, allows easy visualization and differentiation of the voxels of each group from the voxels of the other group.

Any suitable vessel segmentation, also known in the art as a vessel tree extraction algorithm, can be used but it is particularly advantageous if the segmentation is performed by a region growing algorithm comprising wave front propagation. Such algorithms are known as such from, for example, ‘Simultaneous Segmentation and Tree Reconstruction of the Airways for Virtual Bronchoscopy’, Thorsten Schlatholter et al, SPIE 2002, ‘A General Framework for Tree Segmentation and Reconstruction from Medical Volume Data’, Thomas Bülow et al, MICCAI 2004, and ‘Automatic Extraction of the Pulmonary Artery Tree from Multi-Slice CT Data’, Thomas Bülow et al, Medical Imaging 2005: Physiology, Function and Structure from Medical Images, edited by Amir A. Amini, Armando Manduca, Proceedings of SPIE Vol. 5746. Such segmentations provide a particularly accurate vessel tree segmentation and proceed by growing segments representative of the spaces within individual vessel segments and connecting the segments together to form a branching network representative of the real vessel tree in the imaged body. In other words, starting from seed points, connected sub-trees of the vessel tree will be segmented. The segmentation is usually performed in three dimensions on a subtraction image showing the difference between a post-contrast image and the pre-contrast image.

Region growing algorithms grown from an initial seed point start from a point or voxel within an object data set chosen either automatically by some protocol or computer sub-routine or chosen by the viewer of the object data set. A wave-front, usually a fast marching front, is grown out from this seed point and this wave-front walks though the voxels of the object data set, applying a voxel acceptance criterion to each voxel it encounters. If the voxel meets the criterion it is incorporated into the grown volume. The voxel acceptance criterion is used to constrain the wave-front to, in this case, the vessel. The voxel acceptance criterion is usually a threshold and is chosen to be a threshold value which differentiates between voxels representing tissue in the structure to be segmented, in this case a vessel tree, and voxels representing other tissue in the locality. In the current case, an appropriate threshold is a grey level value typical for a voxel representing the wall of the vessel. In the case when the object data set is acquired from computerized tomography, typical values for the threshold adequate to identify the wall of arterial tissue are values in the range of 1100-1300 HU. When the invention is applied to data derived from MR imaging it is found that the inherent variability in the magnetic gradients, which in turn produces a variation in the absolute data point values of the output object data sets, makes selection of the threshold more difficult. One way to calculate a suitable threshold value is to use the Hessian matrix, the calculation of which is known to the person skilled in the art, to use the Hessian to calculate the eigen vectors, itself a known process, and to use the eigen vectors to identify a cross-section of a suitable vessel in the object data set. The center of this cross-section is then calculated and rays are cast out from the central point and the gradient calculated at suitable intervals along each ray. The point at which maximum gradient occurs indicates a voxel whose grey value is suitable for use as the threshold value of the voxel acceptance criterion for that particular case.

The wave-front disintegrates when the wave-front reaches any branching point in the tree. In fact it disintegrates into multiple groups of connected points, usually two due to a bifurcation of the vessel tree. The applied algorithm checks regularly for connectedness across the wave-front and when lack of connectedness is detected the algorithm stops wave-front propagation, identifies the multiple groups of connected points and within each group identifies a new seed point from which a new wave-fronts is propagated. This thereby continues the segmentation procedure. A new seed point can be easily calculated as the voxel at the center of a connected group but it will be understood by the skilled person that since a new wave-front is grown from this point it could in fact be any voxel in the group.

The algorithm includes various checks made at the segment level. The first is the application of a termination criterion to the segment as a whole. Each segment is allowed to proceed to a maximal length before it is stopped and a new seed point calculated in the group of connected voxels at the end of the segment. A validity check is performed by application of a segment evaluation criterion to the segment. This is normally performed during segment expansion because it is more efficient to continue generating a particular segment only if it will lead to a valid segment. However it is theoretically possible to perform this at the end of the procedure when all segments have been generated. A typical reason for segment invalidity is leakage of segmented volume into surrounding tissue due to a failure of the voxel acceptance criterion. Failure of the voxel acceptance criterion can occur due to the partial volume effect in small vessels. In the case of leakage the validity check can be advantageously based on a radius value which represents a value of vessel radius that would not be expected from an anatomical assessment of the tissue under consideration. Alternatively, a ‘vesselness’ filter, as it is known in the art, can be used to validate individual segments. When leakage is detected not only the leakage, but the entire segment attached to the leakage, is removed. The maintenance of a maximal segment length avoids the loss of too great a segment length when leakage occurs.

A segment evaluation criterion is used to regularly evaluate each segment for the acceptance or rejection of the whole segment. New segments are allowably initialized for each connected front component on an accepted segment. Rejected segments are not used to initialize further segments downstream of the initial seed point. Segment evaluation criteria can be grey-value based, for example ‘vesselness’, ‘orientedness’, such criteria often designed on known technique to analyze grey-value distributions within an image space such as use of the Hessian matrix, gradients and ray casting etc, or alternatively can be of a geometric nature and can be based on, for example, maximum segment radius, elongated shape etc.

Segments that turn out to be unacceptable can be regrown using an automatically adapted set of parameters for the various criteria. These parameters are also adapted whenever a new segment is inherited from a parent segment.

Once the segments have been grown, checks are made at the tree level to remove any false segments. These are decisions which can only be taken at the tree level because they cannot be taken by considering a single segment. For example, a sub-tree can be removed if too high a density of branching points indicates a leakage. Criteria can also be included, for example, to remove any false branching points.

Following tree level check the entire tree can be constructed from the constituent segments.

As is known in the art, such region growing algorithms are usually applied to volume data to identify the voxels in a specific tree, but it is possible to apply them also to two dimensional slice data. However, even when applied to volume data the results of applying such a region growing algorithm may be viewed in a two dimensional slice image. The volume data contains voxels representing contrast enhanced material and may therefore be an object data set representing image data acquired after an injection of contrast agent, but may also and more typically be an object data set representing the data set of a post-injection image modified by subtracting equivalent, and often registered, data points from corresponding pre-injection image data. The latter technique has the advantage that there is a much greater difference in voxel value between the voxels representing contrast enhanced materials and all other voxels in the resulting image, the object data set having been, in effect, corrected for background by the subtraction of image data from a corresponding pre-injection image.

The difference between the first and second groups of voxels identified by the invention is advantageously identified to the user by using the partition to calculate a mask in which the first group of voxels are identified. In effect, this is a form of explicit vessel overlay and involves the overlay of the 3D vessel tree onto the visualization. A mask, as is known in the art, is a further object data set in which all data points are either one or zero. This mask, when applied to the second object data set, which can be achieved using techniques known in the art, will identify for the viewer all voxels from the first group in an image derived from the second object data set. In other words it allows visual identification by the viewer of the vessels in the resulting image. If these voxels are further shown in some easily noticeable color they are further rendered more easily noticeable by the viewer and this has particular advantage when viewing the data set as a stack of two dimensional views, as is known in the art, and in which vessel data is truncated due to transverse alignment with the plane of each view. Identification and display of the vessel material has specific diagnostic value because many cancerous lesions become highly vascularized at some point in their development. The visual display of vessel voxels therefore allows easier identification of conglomerations of vessels, which may point to the existence of a highly vascularized cancerous lesion, even if, for some reason, the lesion has not efficiently absorbed the contrast agent and thus does not show clearly on the contrast enhanced image.

Alternatively, the partition may be used to calculate a mask in which the second group of voxels are identified. This can be referred to as vessel suppression. This removes the vessels from the 3D display reducing the risk of blood vessels being mistaken for suspicious lesions. This mask, when applied to the second object data set, will identify for the viewer all voxels from the second group in any image derived from the second object data set. Since the second group can be expected to contain any voxels that represent lesions it is particularly advantageous when the mask data is used to color the second group of voxels in the second object data set. This step has the advantage that any voxels representing contrast enhanced lesion material appear colored in any resultant image and are therefore highly visible to the viewer.

Alternatively, both advantages may be combined by the calculation and display of an image showing both vessel and non-vessel voxels, each type displayed in a different color, or range of colors.

Further options for display of the data include calculation and display of gray-value multi-planar reformats of the raw data, or indeed any kind of data derived from the original object data set, for example subtraction- or enhancement-images, with overlaid 3 dimensional visualization of the blood vessels. This view is particularly advantageous in indicating vessel cross-sections in the multi-planar reformat that could otherwise be misread as suspicious lesions. It also highlights highly vascularized areas, which become particularly obvious in this visualization mode.

The method is particularly advantageous when applied to DCE breast MR imaging because the blood vessels in the human breast are small and therefore difficult to accurately identify on an image in the case when the imaging plane cuts transaxially through the vessel. In this case connectedness of the wave-front propagation is assessed every 1 mm in the invention. A maximal segment length of 1 cm is applied as a termination criterion. A radius termination criterion value of 4 mm is advantageously used because it represents a value of vessel radius which will detect leakage and ensures that no segments are generated which cannot possibly represent genuine vessels in the human breast.

A further advantage is that when the method is applied to breast imaging no checks need be incorporated into the region growing algorithm at the tree level. Tree level checks can be dispensed with due to the smoothness and regularity of the blood vessel tree in the human mammary, and its lack of false branching points in this part of the body. Lack of tree level decision making within the overall tree construction saves on computing power and time.

The result of applying the invention is more accurate contrast enhanced image data.

The invention also relates to a workstation configured to incorporate the string of computer instructions and has the advantage that it is suitable to perform the invention in a workspace suitable for the handling and assessment of medical images.

The invention also relates to a computer aided detection system configured to incorporate the string of computer instructions and has the advantage that it is suitable to perform the invention in a workspace suitable for the application of computer aided detection algorithms to the assessment of medical images for the purposes of diagnosis.

These and other aspects of the invention will be described with the assistance of the following figures.

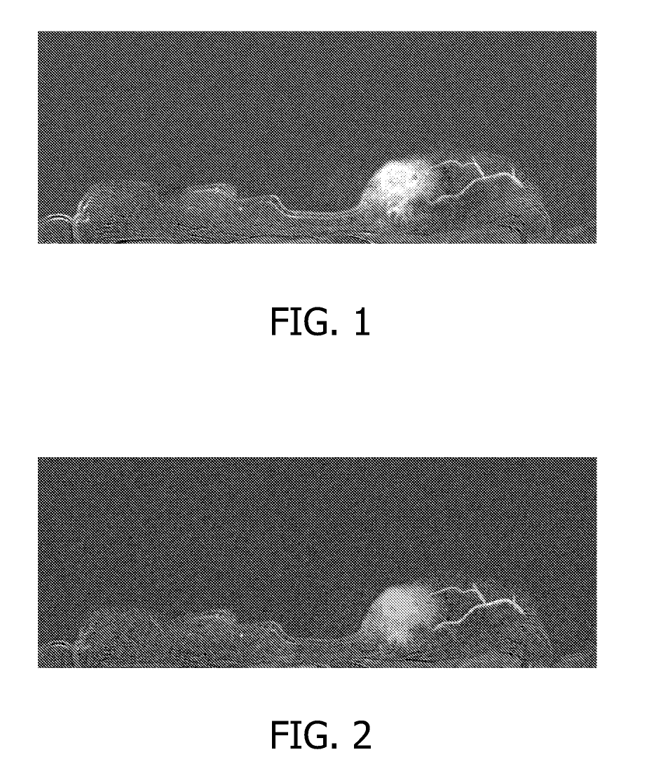

FIG. 1 is a subtraction image showing a breast cancer lesion and parts of the blood vessel tree.

FIG. 2 is a color map rendition of the image of FIG. 1 showing areas of contrast enhancement after signal intensity curves have been produced.

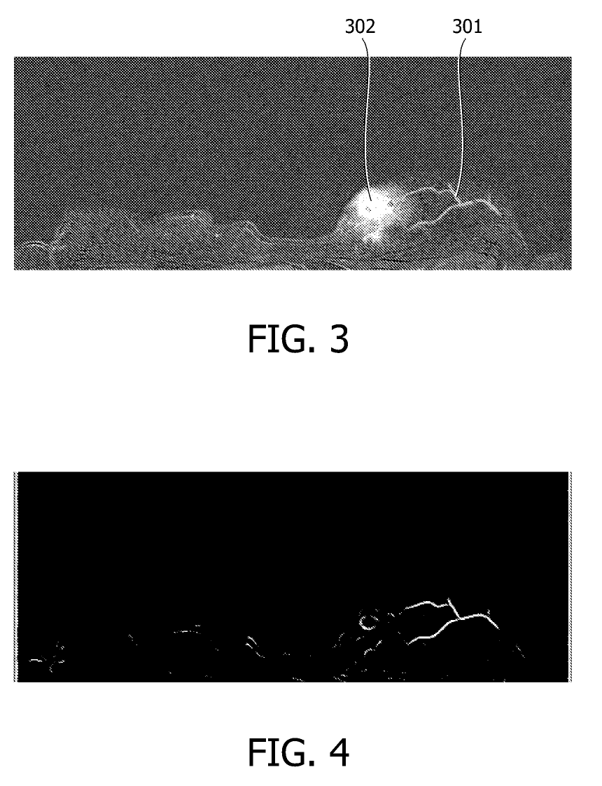

FIG. 3 shows the results of a vessel tree extraction.

FIG. 4 shows the filter response of a vessel enhancement filter which can be used for automatic seed point selection. The vessel tree segmentation can be performed on the vessel enhancement image.

An object data set can be used to construct a 2 dimensional image representing a single slice through the body of tissue represented by the data set, and can also be used to construct an image representing a 3 dimensional body of tissue. The latter is achieved using various volume visualization techniques known in the art.

FIG. 1 is a subtraction image showing a breast cancer lesion and parts of the blood vessel tree. All contrast enhanced material appears bright, but it is not always entirely clear from the image where the vessel tree ends and the lesion begins.

FIG. 2 is a color map showing areas of contrast enhancement after signal intensity curves have been produced. It is clear that the signal intensity curves cannot differentiate between lesion and vessel tree. If the output of the signal intensity curves was used as the direct input to an algorithm for computer aided detection it would cause the algorithm to incorrectly detect the vessels as lesions.

FIG. 3 shows the results of a vessel tree extraction. One seed point was placed interactively. The vessels 301 are now clearly identifiable, separately to the contrast enhanced lesion material 302.

FIG. 4 shows the filter response of a vessel enhancement filter which can be used for automatic seed point selection. The vessel tree segmentation can be performed on the vessel enhancement image.

1. A string of computer instructions to output medical image data containing voxels representative of contrast enhanced material, the string arranged to operate on a first object data set comprising voxels depicting contrast enhancement, and arranged to identify the voxels depicting contrast enhancement, characterized in that
the string is arranged to segment a sub-set of voxels in the first object data set which voxels describe contrast enhanced vessels,
and further arranged to use the results of the segmentation to partition the voxels depicting contrast enhancement into a first group of voxels describing the segmented vessels and a second group of voxels describing the remaining contrast enhanced voxels,
and further arranged to use the partition to output a second object data set comprising a group of voxels depicting contrast enhancement in which any voxels in the first group are visually marked as being of the first group and in which any voxels in the second group are visually marked as being of the second group.

2. A computer string as claimed in claim 1 characterized in that the segmentation is performed by a region growing algorithm comprising wave-front propagation grown from a seed point.

3. A computer string as claimed in claim 2 characterized in that the region growing algorithm comprises instructions to grow a wave-front from an initial seed point, and further comprises instructions to compare individual voxels within the wave-front with an acceptance criterion to either include or exclude the voxel from the grown region.

4. A computer string as claimed in claim 2 characterized in that the region growing algorithm comprises instructions to detect for connectedness of the voxels across the wave-front,
and further including instructions to stop the wave-front propagation if connectedness is not detected,
and further including instructions to calculate the constituent groups of voxels on the stopped wave-front which are connected to each other,
and further including instructions to select a new seed point within individual constituent groups of connected voxels and to start a new wave-front from the new seed point.

5. A computer string as claimed in claim 4 characterized in that a check is made for connectedness of the voxels across the wave-front with each one millimeter expansion of the wave-front.

6. A computer string as claimed in claim 3 characterized in that the acceptance criterion is a grey level threshold value.

7. A computer string as claimed in claim 1 characterized in that the partition is used to calculate a mask identifying the first group of voxels, and is further arranged to apply the mask to the second object data set so that it is suitable for use to produce an image in which the first group of voxels are identified.

8. A computer string as claimed in claim 1 characterized in that the partition is used to calculate a mask identifying the second group of voxels, and is further arranged to apply the mask to the second object data set so that it is suitable for use to produce an image in which the second group of voxels are identified.

9. A computer string as claimed in claim 7 characterized in that the masked voxels are depicted in color.

10. A computer string as claimed in claim 1, characterized in that the visual marking is arranged by display of the voxels in the first group and/or the voxels in the second group in a color or range of colors representing each respective group.

11. A computer string as claimed in claim 1 characterized in that the first object data set comprises voxels representing mammary tissue.

12. A workstation comprising a computer instruction string according to claim 1.

13. A computer aided detection system comprising a computer instruction string according to claim 1.
